(19) United States
(12) Patent Application Publication
(10) Pub. No.: US 2014/0368951 A1
(43) Pub. Date: Dec. 18, 2014

(54) SPINDLE MOTOR AND HARD DISK DRIVE INCLUDING THE SAME

(71) Applicant: Samsung Electro-Mechanics Co., Ltd., Suwon (KR)

(72) Inventors: Dong Hyun LEE, Suwon (KR); Song Bon OH, Suwon (KR)

(73) Assignee: SAMSUNG ELECTRO-MECHANICS CO., LTD., Suwon (KR)

(21) Appl. No.: 13/974,449

(22) Filed: Aug. 23, 2013

(30) Foreign Application Priority Data
Jun. 14, 2013 (KR) 10-2013-0068171

(51) Int. Cl. G11B 19/20; F16C 32/06

(52) U.S. Cl. CPC G11B 19/2036; F16C 32/06
USPC 360/99.08; 384/107

(57) ABSTRACT

There are provided a spindle motor including a second thrust member installed on a base member; a shaft installed on the second thrust member; a sleeve disposed above the second thrust member and installed to be rotatable with respect to the shaft; a rotor hub coupled to the sleeve; and a first thrust member disposed above the sleeve and installed on the shaft, wherein the sleeve includes a circulation hole penetrating therethrough in an axial direction, the sleeve and the first thrust member include a first thrust bearing formed therebetween and the sleeve and the second thrust member include a second thrust bearing formed therebetween, and an area by which an upper end portion of the circulation hole is overlapped with the first thrust bearing is larger than an area by which a lower end portion of the circulation hole is overlapped with the second thrust bearing.

### CROSS-REFERENCE TO RELATED APPLICATIONS

This application claims the priority of Korean Patent Application No. 10-2013-0068171 filed on Jun. 14, 2013, in the Korean Intellectual Property Office, the disclosure of which is incorporated herein by reference.

### BACKGROUND OF THE INVENTION

1. Field of the Invention

The present invention relates to a spindle motor and a hard disk drive including the same.

2. Description of the Related Art

In an information recording and reproducing device such as a hard disk driving device for a server, or the like, a fixed shaft type spindle motor in which a shaft having excellent vibration characteristics is fixed to a case of the hard disk driving device is mainly used.

That is, the shaft is fixedly installed in the spindle motor mounted in the hard disk driving device for a server in order to prevent information recorded on a disk from being damaged and becoming unreadable or to prevent a disk from being unable to record information due to a large amount of amplitude in a rotor caused by external vibrations.

As described above, in the case in which the fixed type shaft is installed, thrust members are fixedly installed on upper and lower portions of the shaft, respectively, and first and second liquid-vapor interfaces are formed between the upper thrust member and a sleeve and the lower thrust member and the sleeve, respectively.

However, the first liquid-vapor interface may be in communication with an upper portion of the spindle motor by a labyrinth seal, or the like, and the upper portion of the spindle motor may have a disk, or the like, mounted thereon, to thereby be utilized as a storage memory. Therefore, in the case in which a lubricating fluid is leaked to the outside of the first liquid-vapor interface, there is a risk that the disk, or the like, will be polluted therewith.

### SUMMARY OF THE INVENTION

An aspect of the present invention provides a spindle motor capable of preventing a lubricating fluid from being leaked to the outside of the spindle motor even in the case in which the lubricating fluid is leaked to the outside of a liquid-vapor interface.

An aspect of the present invention provides a spindle motor having a structure capable of significantly decreasing an amount of lubricating fluid leaked through each of the first and second liquid-vapor interfaces included in the spindle motor.

According to an aspect of the present invention, there is provided a spindle motor including: a second thrust member fixedly installed on a base member; a shaft fixedly installed on the second thrust member; a sleeve disposed above the second thrust member and installed to be rotatable with respect to the shaft; a rotor hub coupled to the sleeve to thereby be rotated together with the sleeve; and a first thrust member disposed above the sleeve and fixedly installed on the shaft, wherein the sleeve includes a circulation hole penetrating therethrough in an axial direction, the sleeve and the first thrust member include a first thrust bearing formed therebetween and the sleeve and the second thrust member include a second thrust bearing formed therebetween, and an area by which an upper end portion of the circulation hole in the axial direction is overlapped with the first thrust bearing is larger than an area by which a lower end portion of the circulation hole in the axial direction is overlapped with the second thrust bearing.

A cross-sectional area of the upper end portion of the circulation hole in the axial direction may be larger than that of the lower end portion of the circulation hole in the axial direction.

The upper end portion of the circulation hole in the axial direction may be provided with a diameter increasing part having a diameter larger than those of other portions of the circulation hole.

A cross section of the circulation hole in the axial direction may form a circle having a predetermined diameter, and the diameter increasing part may be formed as a circle having a diameter larger than those of other portions of the circulation hole.

The center of a circle formed by a cross section of the diameter increasing part in the axial direction may be offset from those of circles formed by cross sections of other portions of the circulation hole in the axial direction.

A cross-sectional area of the upper end portion of the circulation hole in the axial direction may be the same as that of the lower end portion of the circulation hole in the axial direction.

The circulation hole may have a diameter that increases in an upward axial direction.

The lower end portion of the circulation hole in the axial direction may have a diameter decreasing member in which a hole having a diameter smaller than that of the circulation hole is formed in the axial direction inserted thereinto.

The lower end portion of the circulation hole in the axial direction may be formed outside of a region of the second thrust bearing.

A first sealing part provided between the first thrust member and a member facing the first thrust member in a radial direction may be formed as a space smaller than that of a second sealing part provided between the second thrust member and the sleeve.

The member facing the first thrust member in the radial direction may be the rotor hub.

The member facing the first thrust member in the radial direction may be the sleeve.

The first and second sealing parts may be lengthily formed in the axial direction, and the first and second sealing parts may include first and second liquid-vapor interfaces formed therein, respectively.

When the shaft is rotated, a first liquid-vapor interface formed in the first sealing part may move toward the upper end portion of the circulation hole in the axial direction and a second liquid-vapor interface formed in the second sealing part may move toward an opposite side of the lower end portion of the circulation hole in the axial direction.

A first sealing part provided between the first thrust member and a member facing the first thrust member in a radial direction may have an axial length shorter than that of a second sealing part provided between the second thrust member and the sleeve.

The circulation hole may be inclined with respect to the axial direction.

According to another aspect of the present invention, there is provided a spindle motor including: a second thrust member fixedly installed on a base member; a shaft fixedly installed on the second thrust member; a sleeve disposed above the second thrust member and installed to be rotatable with respect to the shaft; a rotor hub coupled to the sleeve to thereby be rotated together with the sleeve; and a first thrust member disposed above the sleeve and fixedly installed on the shaft, wherein The sleeve includes a circulation hole penetrating therethrough in an axial direction, and when the shaft is rotated, a greater amount of pressure is generated at an upper end portion of the circulation hole in the axial direction than at a lower end portion of the circulation hole in the axial direction.

According to another aspect of the present invention, there is provided a hard disk drive including: the spindle motor as described above rotating a disk by power applied thereto through a substrate; a magnetic head writing data to and reading data from the disk; and a head transfer part moving the magnetic head to a predetermined position above the disk.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor according to an embodiment of the present invention;

FIG. 2 is an enlarged view of part A of FIG. 1;

FIG. 3 is a partially cut-away exploded perspective view showing a sleeve and first and second thrust members according to the embodiment of the present invention;

FIG. 4 is a view for describing an operation of the spindle motor according to the embodiment of the present invention;

FIGS. 5A and 5B are plan views showing upper and lower surfaces of the sleeve according to the embodiment of the present invention, respectively;

FIGS. 6A through 6F are cross-sectional views showing various changes in shape of a circulation hole formed in the sleeve according to the embodiment of the present invention;

FIGS. 7A and 7B are plan views showing changes in shape of the upper and lower surfaces of the sleeve according to the embodiment of the present invention, respectively;

FIGS. 8A and 8B are plan views showing other changes in shape of the upper and lower surfaces of the sleeve according to the embodiment of the present invention, respectively;

FIG. 9 is a schematic cross-sectional view showing a spindle motor according to another embodiment of the present invention;

FIG. 10 is an enlarged view showing part B of FIG. 9; and

FIG. 11 is a schematic cross-sectional view showing a recording disk driving device having the spindle motor according to the embodiment of the present invention mounted therein.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

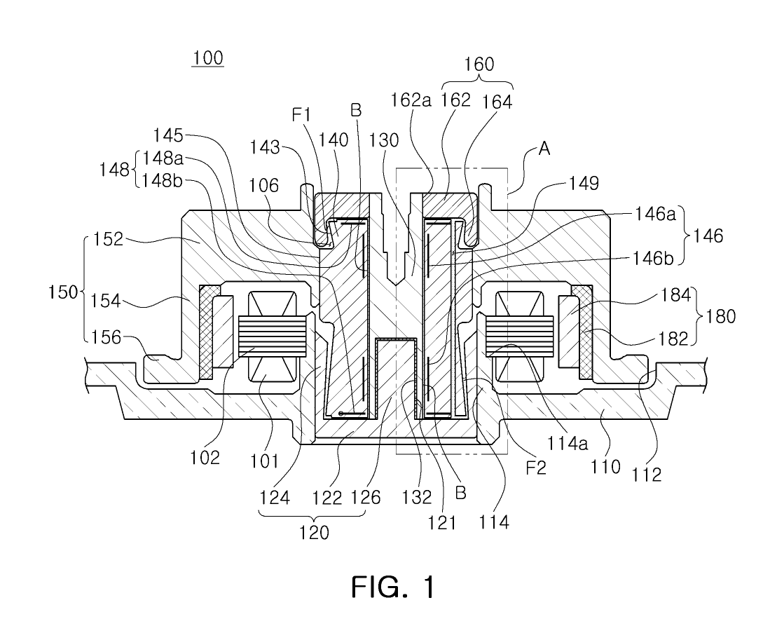

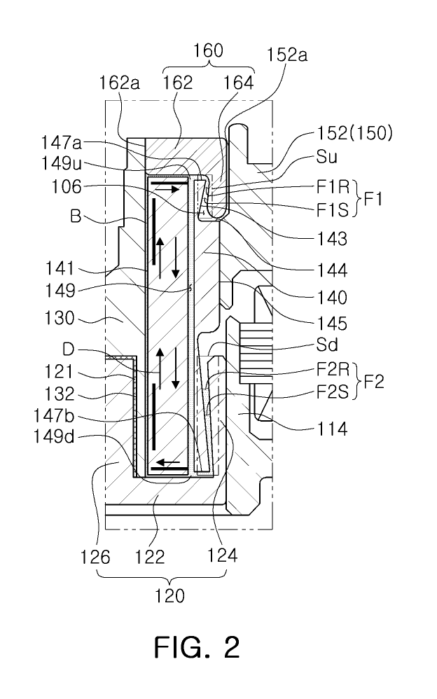

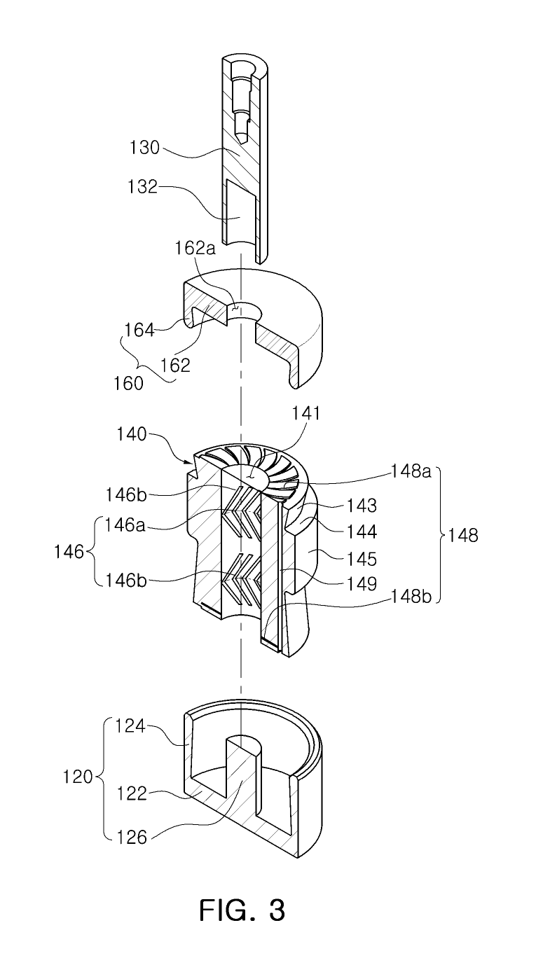

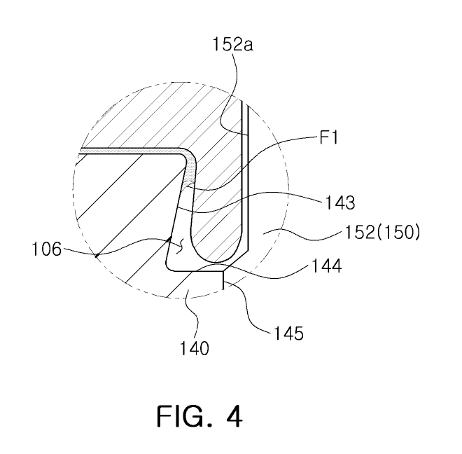

FIG. 1 is a schematic cross-sectional view showing a spindle motor according to an embodiment of the present invention; FIG. 2 is an enlarged view of part A of FIG. 1; FIG. 3 is a partially cut-away exploded perspective view showing a sleeve and first and second thrust members according to the embodiment of the present invention; and FIG. 4 is a view for describing an operation of the spindle motor according to the embodiment of the present invention.

Referring to FIGS. 1 through 4, the spindle motor 100 according to the embodiment of the present invention may include a base member 110, a second thrust member 120, a shaft 130, a sleeve 140, a rotor hub 150, and a first thrust member 160. Here, terms with respect to directions will be defined. As viewed in FIG. 1, an axial direction refers to a vertical direction, that is, a direction from a lower portion of the shaft 130 toward an upper portion thereof or a direction from the upper portion of the shaft 130 toward the lower portion thereof, a radial direction refers to a horizontal direction, that is, a direction from the shaft 130 toward an outer peripheral surface of the rotor hub 150 or from the outer peripheral surface of the rotor hub 150 toward the shaft 130, and a circumferential direction refers to a rotation direction along a predetermined radius at the center of rotation.

In addition, the second thrust member 120 may be included, together with the base member 110, in a fixed member, that is, a stator.

The base member 110 may include a mounting groove 112 so as to form, together with the rotor hub 150, a predetermined space. In addition, the base member 110 may include a coupling part 114 extended in an upward axial direction and having a stator core 102 installed on an outer peripheral surface thereof.

In addition, the coupling part 114 may have a seating surface 114a provided on the outer peripheral surface thereof so that the stator core 102 may be seated and installed thereon. Further, the stator core 102 seated on the coupling part 114 may be disposed above the mounting groove 112 of the base member 110 described above.

Here, the base member 110 may be manufactured by die-casting aluminum (Al) or be manufactured by performing plastic working (for example, press working) on a steel sheet.

The second thrust member 120 may be fixedly mounted on the base member 110. That is, the second thrust member 120 may be insertedly installed in the coupling part 114. More specifically, the second thrust member 120 may be installed so that an outer peripheral surface thereof is bonded to an inner peripheral surface of the coupling part 114.

Meanwhile, the second thrust member 120 may include a disk part 122 having an outer surface fixedly installed on the base member 110, an extension part 124 extended from an outer edge of the disk part 122 in the upward axial direction, and a fitting protrusion 126 protruding from the center of the disk part 122 in the upward axial direction to thereby be fitted into a fixing groove 132 formed in a lower end of a shaft 130 to be described below.

That is, the second thrust member 120 may have a cup shape in which it has a hollow and includes a protrusion formed in the center of the hollow. In other words, the second thrust member 120 may have an ‘E’ shaped cross section.

A lower end surface of the shaft 130 in the axial direction may be provided with a fixing groove 132 depressed in the upward axial direction, and the fitting protrusion 126 of the second thrust member 120 may be fitted into the fixing groove 132. As a coupling scheme, various coupling schemes such as an adhesive bonding scheme, a sliding-fitting scheme, a screwing scheme, a press-fitting scheme, and the like, may be used.

A shape of the second thrust member 120 described in the embodiment of the present invention is only an example. Therefore, a shape of the second thrust member 120 may be variously changed. In addition, the second thrust member 120 may be coupled to the shaft 130 in various schemes. For example, the second thrust member 120 may have a cup shape, and a lower end of the shaft 130 may be fitted into and fixed to a fixing hole provided at the second thrust member 120.

Meanwhile, a second thrust dynamic groove 148b for generating thrust fluid dynamic pressure may be formed in at least one of an upper surface of the second thrust member 120 and a lower surface of the sleeve 140 facing the upper surface of the second thrust member 120. When the sleeve 140 is rotated, a second thrust dynamic bearing may be formed by the second thrust dynamic groove 148b.

The shaft 130 may be fixedly installed on the second thrust member 120. That is, the fitting protrusion 126 included in the second thrust member 120 may be fitted into the fixing groove 132 formed in the lower end surface of the shaft 130, such that the shaft 130 may be firmly fixed to the second thrust member 120.

That is, the lower end surface of the shaft 130 in the axial direction may be provided with the fixing groove 132 depressed in the upward axial direction, and the fitting protrusion 126 of the second thrust member 120 may be fitted into the fixing groove 132. As a coupling scheme, various coupling schemes such as an adhesive bonding scheme, a sliding-fitting scheme, a screwing scheme, a press-fitting scheme, and the like, may be used.

Although the case in which the shaft 130 is fixedly installed on the second thrust member 120 has been described by way of example in the present embodiment, the present invention is not limited thereto. For example, in the case in which the second thrust member 120 is formed integrally with the base member 110, the shaft 130 may also be fixedly installed on the base member 110.

Meanwhile, the shaft 130 may be also included, together with the second thrust member 120 and the base member 110, in the fixed member, that is, the stator.

An upper surface of the shaft 130 may be provided with a coupling unit, for example, a screw part having a screw screwed thereto, so that a cover member (not shown) may be fixedly installed thereto.

Meanwhile, the shaft 130 may include radial dynamic grooves 146 formed at upper and lower portions of an outer surface thereof. More specifically, the shaft 130 may include first and second radial dynamic grooves 146a and 146b formed at the upper and lower portion thereof in the axial direction. The radial dynamic groove 146 may also be formed in the sleeve 140 facing the shaft 130.

The sleeve 140 may be installed so as to be rotatable with respect to the shaft 130. To this end, the sleeve 140 may include a through-hole 141 into which the shaft 130 is inserted. Meanwhile, in the case in which the sleeve 140 is installed on the shaft 130, an inner peripheral surface of the sleeve 140 and an outer peripheral surface of the shaft 130 may be disposed to be spaced apart from each other by a predetermined interval to form a bearing clearance B therebetween. In addition, the bearing clearance B may be filled with the lubricating fluid.

Meanwhile, the sleeve 140 may have an inclination part 143 formed at an upper end portion thereof so as to form, together with the first thrust member 160, a liquid-vapor interface, wherein the inclination part 143 has an outer diameter larger in an upper portion thereof than in a lower portion thereof.

In other words, the inclination part 143 having an outer diameter larger in the upper portion thereof than in the lower portion thereof may be formed at the upper end portion of the sleeve 140 so that a first liquid-vapor interface F1 may be formed in a space between an outer peripheral surface of the sleeve 140 and an inner peripheral surface of the first thrust member 160.

Meanwhile, the sleeve 140 may include a step surface 144 formed at the upper end portion thereof, wherein the step surface 144 is stepped with respect to an upper surface of the sleeve 140 to thereby form a sealing groove 106. A detailed description of the step surface 144 will be provided below.

In addition, the sleeve 140 may include the rotor hub 150 bonded to the outer peripheral surface thereof. That is, a lower portion of the step surface 144 may have a shape corresponding to that of an inner surface of the rotor hub 150, such that the rotor hub 150 may be fixedly installed thereto. That is, the sleeve 140 may include a bonding surface 145 formed on the outer peripheral surface thereof. Here, the sleeve 140 and the rotor hub 150 may be formed integrally with each other. In the case in which the sleeve 140 and the rotor hub 150 are formed integrally with each other, since both the sleeve 140 and the rotor hub 150 are provided as single members, the number of components is decreased, whereby a product may be easily assembled.

Meanwhile, a lower end portion of the outer peripheral surface of the sleeve 140 may be inclined upwardly in the inner diameter direction so as to form, together with the extension part 124 of the second thrust member 120, a liquid-vapor interface.

That is, the lower end portion of the sleeve 140 may be inclined upwardly in the inner diameter direction so that a second liquid-vapor interface F2 may be formed in a space between the outer peripheral surface of the sleeve 140 and the extension part 124 of the second thrust member 120.

As described above, since the second liquid-vapor interface F2 is formed in the space between the lower end portion of the sleeve 140 and the extension part 124, the lubricating fluid filled in the bearing clearance B may form the first and second liquid-vapor interfaces F1 and F2.

In addition, the sleeve 140 may include a radial dynamic groove 146 formed in an inner surface thereof in order to generate fluid dynamic pressure in the lubricating fluid filled in the bearing clearance B at the time of rotation thereof. That is, the radial dynamic groove 146 may include first and second radial dynamic grooves 146a and 146b, as shown in FIGS. 1 through 3.

However, the radial dynamic groove 146 is not limited to being formed in the inner surface of the sleeve 140, but may also be formed in the outer peripheral surface of the shaft 130. In addition, the radial dynamic groove 146 may have various patterns such as a herringbone pattern, a spiral pattern, a screw pattern, and the like.

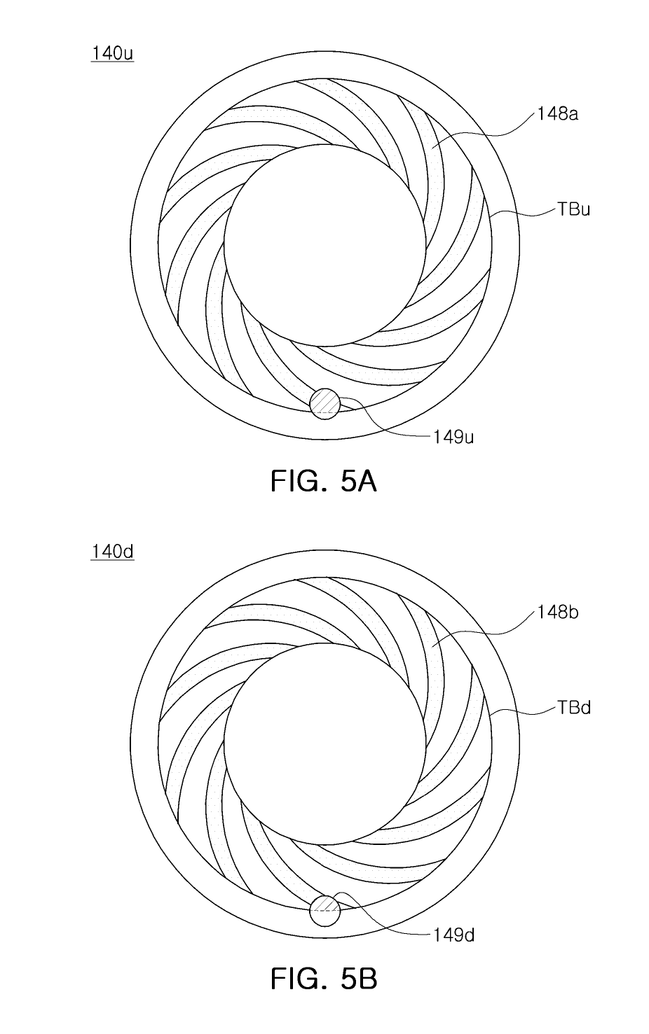

In addition, the sleeve 140 may be provided with a circulation hole 149 penetrating therethrough in the axial direction. The circulation hole 149 may be formed to prevent the generation of negative pressure in the bearing clearance B and easily discharge air bubbles that may be formed in the lubricating fluid. The circulation hole 149 may be provided in parallel with the axial direction or may be inclined upwardly or downwardly. A shape of the circulation hole 149 will be described below with reference to FIGS. 5A through 8B.

In addition, outer side portions of an upper end portion and a lower end portion of the circulation hole 149 may have steps 147a and 147b formed in the radial direction of the sleeve 140. Since the inner side portion of the circulation hole 149 substantially forms the thrust dynamic bearing, the outer side portion of the circulation hole 149 may be stepped so as to increase an interval between the circulation hole and a member facing the circulation hole in order to decrease power consumption. The steps 147a and 147b may be formed in the first and second thrust members 160 and 120 facing upper and lower surfaces of the sleeve 140, respectively, as well as the sleeve 140.

Meanwhile, in the case in which a rotating member including the sleeve 140 and the rotor hub 150 is rotated, a first thrust bearing may be formed between the sleeve 140 and the first thrust member 160 by the first thrust dynamic groove 148a, and a second thrust bearing may be formed between the sleeve 140 and the second thrust member 120 by the second thrust dynamic groove 148b.

Here, an area by which an upper end portion 149u of the circulation hole 149 in the axial direction is overlapped with the first thrust bearing may be larger than an area by which a lower end portion 149d of the circulation hole 149 in the axial direction is overlapped with the second thrust bearing. This may also be applied to the case in which although not shown, the lower end portion 149d of the circulation hole 149a in the axial direction is formed at an outer side of a region of the second thrust bearing, such that an area by which the lower end portion 149d of the circulation hole 149 in the axial direction is overlapped with the second thrust bearing is not present.

Therefore, in the case in which the rotating member including the sleeve 140 and the rotor hub 150 is rotated, a greater amount of pressure may be generated at the upper end portion 149u of the circulation hole in the axial direction than at the lower end portion 149d of the circulation hole in the axial direction to allow the lubricating fluid to move from an upper portion in the axial direction to a lower portion in the axial direction within the circulation hole 149, thereby effectively preventing the lubricating fluid from being leaked to the outside of the spindle motor through the first liquid-vapor interface F1.

That is, when the rotating member including the sleeve 140 and the rotor hub 150 is rotated, since the lubricating fluid moves in the downward axial direction within the circulation hole 149 by the above-mentioned mechanism, the lubricating fluid may be circulated in a direction of an arrow (D) as shown in FIG. 2.

Therefore, as shown in FIG. 2, when the rotating member including the sleeve 140 and the rotor hub 150 is rotated, the first liquid-vapor interface formed in the first sealing part Su may move toward the upper end portion 149u of the circulation hole in the axial direction and the second liquid-vapor interface formed in the second sealing part Sd may move toward an opposite side of the lower end portion 149d of the circulation hole in the axial direction. More specifically, the first liquid-vapor interface may move in the upward axial direction (F1S→F1R) and the second liquid-vapor interface may also move in the upward axial direction (F2S→F2R).

Therefore, the first sealing part Su provided between the first thrust member 160 and a member facing the first thrust member 160 in the radial direction may be formed as a space smaller than that of the second sealing part Sd provided between the second thrust member 120 and the sleeve 140 facing the second thrust member 120 in the radial direction. In other words, the first sealing part Su provided between the first thrust member 160 and the member facing the first thrust member 160 in the radial direction may have an axial length shorter than that of the second sealing part Sd provided between the second thrust member 120 and the sleeve 140 facing the second thrust member 120 in the radial direction. The reason why the second sealing part Sd has a size larger than that of the first sealing part Su is that the lubricating fluid moves in the downward axial direction, that is, from the first sealing part Su to the second sealing part Sd, depending on a difference between pressures applied to the upper end portion 149u and the lower end portion 149d of the circulation hole 149.

Here, the member facing the first thrust member 160 in the radial direction may be the sleeve 140. More specifically, an inner surface of a protrusion part 164 of the first thrust member 160 in the radial direction may face an outer surface of an upper surface of the sleeve 140 in the radial direction.

The rotor hub 150 may be coupled to the sleeve 140 to thereby be rotated together with the sleeve 140.

The rotor hub 150 may include a rotor hub body 152 provided with an insertion part 152a in which the first thrust member 160 is insertedly disposed, a mounting part 154 extended from an edge of the rotor hub body 152 and including a magnet assembly 180 mounted on an inner surface thereof, and an extension part 156 extended from an edge of the mounting part 154 in an outer diameter direction.

Meanwhile, a lower end portion of an inner surface of the rotor hub body 152 may be bonded to an outer surface of the sleeve 140. That is, the lower end portion of the inner surface of the rotor hub body 152 and the bonding surface 145 of the sleeve 140 may be coupled to each other in a press-fitting or sliding scheme or be bonded to each other by an adhesive and/or welding.

Therefore, the sleeve 140 may be rotated together with the rotor hub 150 at the time of rotation of the rotor hub 150.

In addition, the mounting part 154 may be extended from the rotor hub body 152 in the downward axial direction. Further, the mounting part 154 may include the magnet assembly 180 fixedly installed on the inner surface thereof.

Meanwhile, the magnet assembly 180 may include a yoke 182 fixedly installed on the inner surface of the mounting part 154 and a magnet 184 installed on an inner peripheral surface of the yoke 182.

The yoke 182 may serves to allow a magnetic field from the magnet 184 to be directed toward the stator core 102 to increase a magnetic flux density. Meanwhile, the yoke 182 may have a circular ring shape or have a shape in which one end portion thereof is bent so as to increase the magnetic flux density by the magnetic field generated from the magnet 184.

The magnet 184 may have an annular ring shape and be a permanent magnet generating a magnetic field having a predetermined strength by alternately magnetizing an N pole and an S pole in the circumferential direction.

Meanwhile, the magnet 184 may be disposed to face a front end of the stator core 102 having a coil 101 wound therearound and generate driving force capable of rotating the rotor hub 150 through electromagnetic interaction with the stator core 102 having the coil 101 wound therearound.

That is, when power is supplied to the coil 101, the driving force capable of rotating the rotor hub 150 is generated by the electromagnetic interaction between the stator core 102 having the coil 101 wound therearound and the magnet 184 disposed to face the stator core 102, such that the rotor hub 150 may be rotated together with the sleeve 140.

The first thrust member 160 may include a fixing hole 162a into which an upper end portion of the shaft 130 is fitted to thereby be fixedly installed on the upper end portion of the shaft 130 and form, together with the sleeve 140, the first liquid-vapor interface.

Meanwhile, the first thrust member 160 may include a body 162 including the fixing hole 162a so that an inner surface thereof is bonded to the shaft 130 and the protrusion part 164 extended from the body 162 and forming, together with the inclination part 163, the liquid-vapor interface.

The protrusion part 164 may be extended from the body 162 in the downward axial direction and have an inner surface disposed to face the inclination part 143.

In addition, the protrusion part 164 may be extended from the body 162 so as to be in parallel with the shaft 130.

Further, the first thrust member 160 may be insertedly disposed in a space formed by the upper end portion of the outer peripheral surface of the shaft 130, the outer surface of the sleeve 140, and the inner surface of the rotor hub 150.

In addition, the first thrust member 160, which is also a fixed member fixedly installed together with the base member 110, the second thrust member 120, and the shaft 130, may be a member configuring the stator.

Meanwhile, since the first thrust member 160 is fixedly installed on the shaft 130 and the sleeve 140 is rotated together with the rotor hub 150, the first liquid-vapor interface F1S or F1R formed in the space between the inclination part 143 of the sleeve 140 and the protrusion part 164 may be inclined toward the inclination part 143 of the sleeve 140 as shown in FIG. 4 at the time of rotation of the sleeve 140.

That is, the first liquid-vapor interface F1S or F1R is inclined toward the outer peripheral surface of the sleeve 140, whereby scattering of the lubricating fluid may be further decreased by centrifugal force.

In addition, an outer peripheral surface of the first thrust member 160 and the inner surface of the rotor hub 150 disposed to face the outer peripheral surface of the first thrust member 160 may forma labyrinth seal. That is, the outer peripheral surface of the first thrust member 160 and the inner surface of the rotor hub body 152 may be disposed to be spaced apart from each other by a predetermined interval and form the labyrinth seal so as to suppress movement of air containing evaporated lubricating fluid to the outside.

Therefore, the movement of the air containing evaporated lubricating fluid to the outside is suppressed, whereby leakage of the lubricating fluid may be suppressed.

In addition, the outer peripheral surface of the first thrust member 160 and the inner surface of the rotor hub body 152 may form a clearance of 0.3 mm or less.

Meanwhile, the first thrust dynamic groove 148a for generating thrust dynamic pressure may be formed in at least one of a lower surface of the first thrust member 160 and the upper surface of the sleeve 140 disposed to face the lower surface of the first thrust member 160.

In addition, the first thrust member 160 may also serve as a sealing member preventing the lubricating fluid filled in the bearing clearance B from being leaked upwardly.

The clearance between the first thrust member 160 and the rotor hub 150 is narrow to suppress outflow of the air containing the evaporated lubricating fluid to the outside, whereby a decrease in the lubricating fluid filled in the upper bearing clearance B may be suppressed.

Meanwhile, the sleeve 140, which is the rotating member among the rotating member (that is the sleeve) and the fixed member (that is the first and second thrust members) that form the liquid-vapor interfaces, that is, the first and second liquid-vapor interfaces F1 and F2, is disposed at an inner side of the fixed member in the radial direction, whereby scattering of the lubricating fluid may be decreased by centrifugal force.

Next, various changes in shape of a circulation hole according to the embodiment of the present invention will be described with reference to FIGS. 5A through 8B.

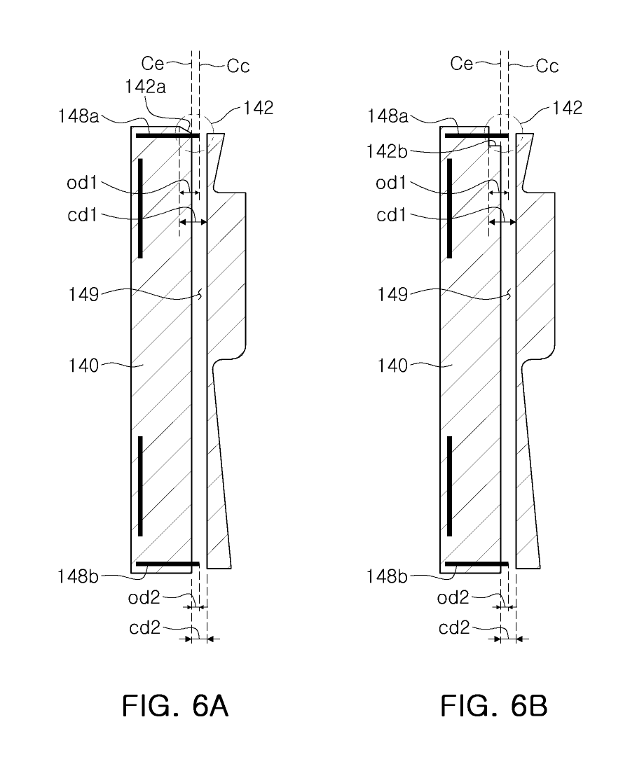

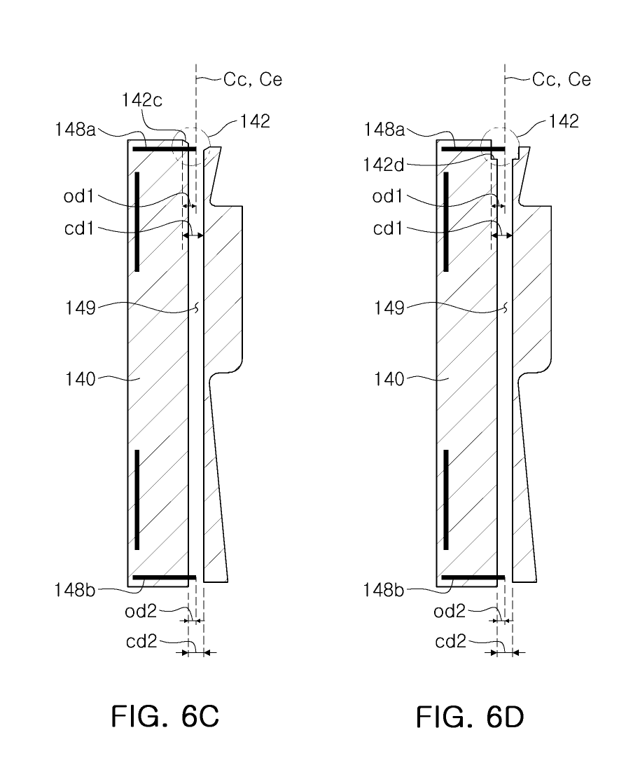

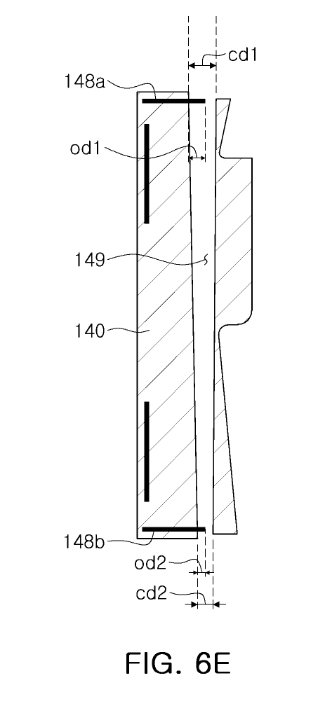

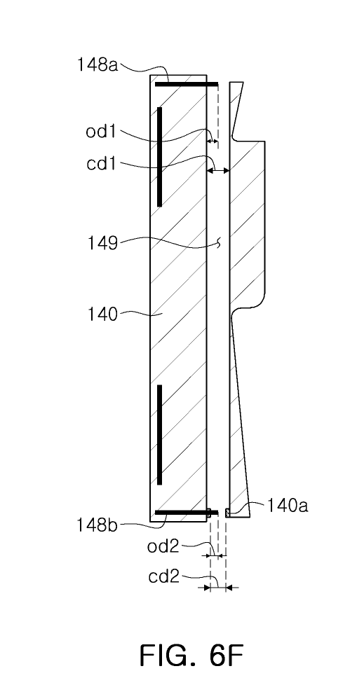

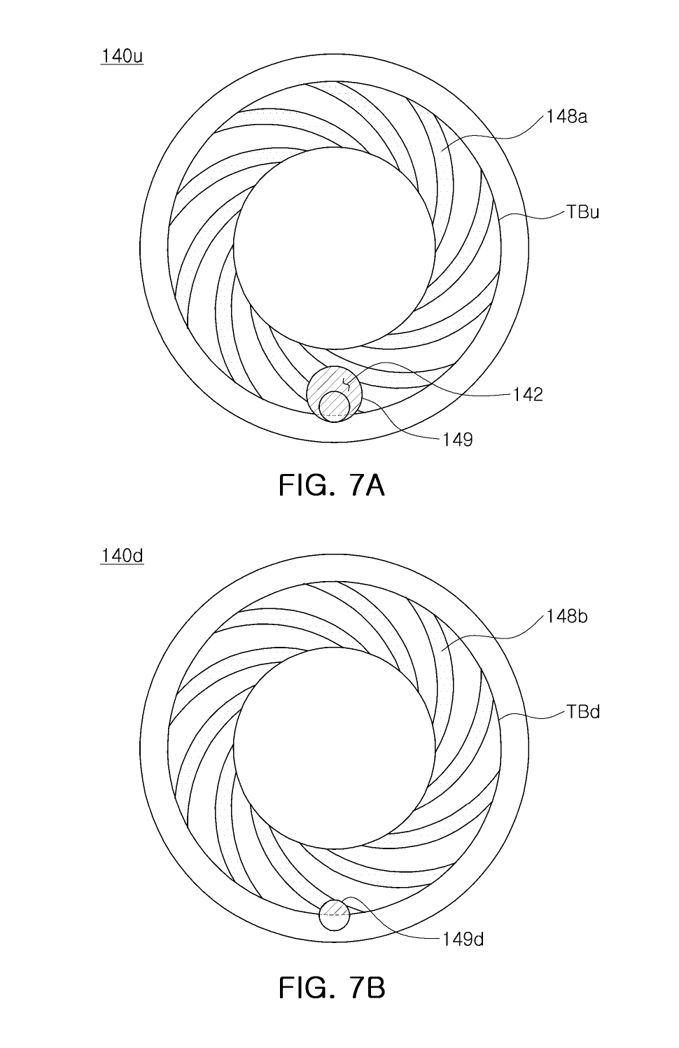

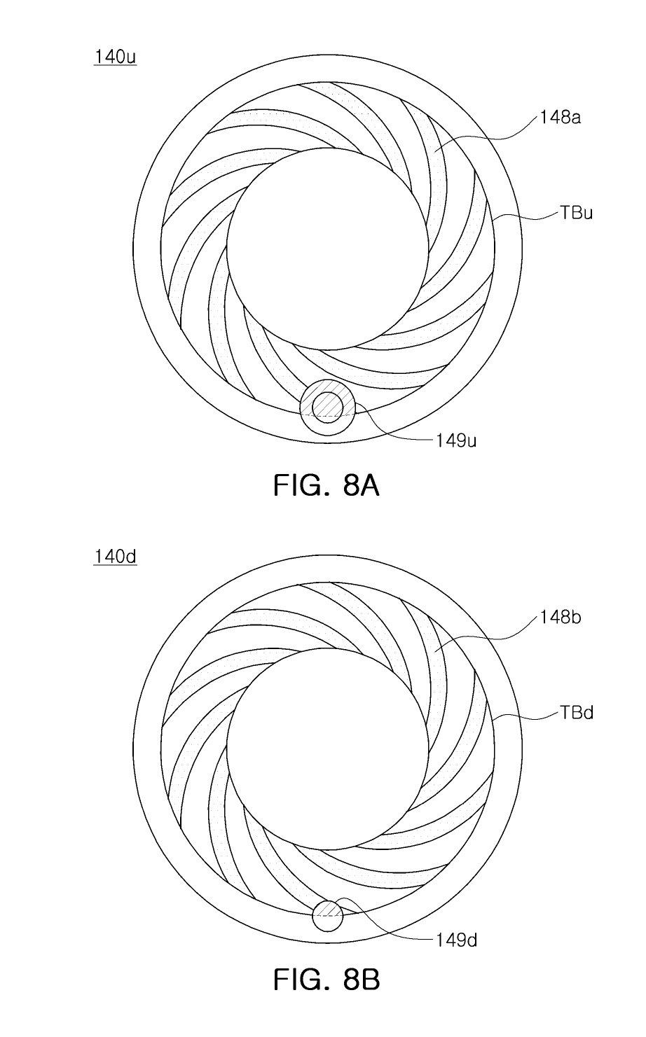

FIGS. 5A and 5B are plan views showing upper and lower surfaces of the sleeve according to the embodiment of the present invention, respectively; FIGS. 6A through 6F are cross-sectional views showing various changes in shape of a circulation hole formed in the sleeve according to the embodiment of the present invention; FIGS. 7A and 7B are plan views showing changes in shape of the upper and lower surfaces of the sleeve according to the embodiment of the present invention, respectively; and FIGS. 8A and 8B are plan views showing other changes in shape of the upper and lower surfaces of the sleeve according to the embodiment of the present invention, respectively.

First, in FIGS. 5A and 5B, plan views of the upper and lower surfaces of the sleeve 140 included in the spindle motor 100 according to the embodiment of the present invention are shown, respectively. The case in which a diameter of the circulation hole 149 formed in the sleeve 140 is constant in the axial direction will be described with reference to FIGS. 5A and 5B.

As shown in FIG. 5A, an upper surface 140u of the sleeve may be provided with the first thrust dynamic groove 148a and an upper end portion of the circulation hole 149 may be in communication with a portion at which the first thrust dynamic groove 148a is provided so as to be overlapped with the portion. Here, the portion at which the first thrust dynamic groove 148a is provided and the first thrust member 160 may have a first thrust bearing formed therebetween, wherein the first thrust bearing is formed between circles formed in the circumferential direction by inner and outer edges of the first thrust dynamic groove 148a in the radial direction. That is, a portion denoted by ‘TBu’ in FIG. 5A may correspond to a portion at which the first thrust bearing is formed. In addition, a hatching portion in the upper end portion 149u of the circulation hole may correspond to a portion overlapped with the first thrust bearing.

As shown in FIG. 5B, a lower surface 140d of the sleeve may be provided with the second thrust dynamic groove 148b and a lower end portion of the circulation hole 149 may be in communication with a portion at which the second thrust dynamic groove 148b is provided so as to be overlapped with the portion. Here, the portion at which the second thrust dynamic groove 148b is provided and the second thrust member 120 may have a second thrust bearing formed therebetween, wherein the second thrust bearing is formed between circles formed in the circumferential direction by inner and outer edges of the second thrust dynamic groove 148b in the radial direction. That is, a portion denoted by ‘TBd’ in FIG. 5B may correspond to a portion in which the second thrust bearing is formed. In addition, a hatching portion in the lower end portion 149d of the circulation hole may correspond to a portion overlapped with the second thrust bearing.

In this case, the hatching portion in the upper end portion 149u of the circulation hole corresponding to the portion overlapped with the first thrust bearing may have an area larger than that of the hatching portion in the lower end portion 149d of the circulation hole corresponding to the portion overlapped with the second thrust bearing.

Next, the case in which a diameter of the circulation hole 149 formed in the sleeve 140 included in the spindle motor 100 according to the embodiment of the present invention is not constant in the axial direction, but is larger at an upper end portion of the circulation hole 149 than at a lower end portion thereof will be described with reference to FIGS. 6A through 8B.

In FIGS. 6A, 6B, 7A, and 7B, a shape in which an interval increasing part 142 is provided at the upper end portion 149u of the circulation hole 149 of the sleeve 140 is shown. Particularly, the center of the interval increasing part 142 is eccentric in the inner diameter direction, that is, a direction toward the first thrust dynamic groove 148a, from the center of the circulation hole 149, such that an area by which the upper end portion 149u of the circulation hole 149 is overlapped with the first thrust bearing TBu formed by the first thrust dynamic groove 148a may be increased. That is, in FIGS. 6A and 6B, ‘Od1’ may be larger than ‘Od2’.

Referring to FIG. 6A, the upper end portion of the circulation hole 149 of the sleeve 140 may be provided with the interval increasing part 142 having a diameter increased in the inner diameter direction. The interval increasing part 142 may have a larger diameter based on the center Ce eccentric in the inner diameter direction from the center Cc of the circulation hole 149. Therefore, a diameter of the upper end portion 149u of the circulation hole 149 may be increased. Meanwhile, an inner surface of the diameter increasing part 142 may be formed as an inclination part 142a having an inclination surface.

Referring to FIG. 6B, the upper end portion of the circulation hole 149 of the sleeve 140 may be provided with the interval increasing part 142 having a diameter increased in the inner diameter direction. The interval increasing part 142 may have a larger diameter based on the center Ce eccentric in the inner diameter direction from the center Cc of the circulation hole 149. Therefore, a diameter of the upper end portion 149u of the circulation hole 149 may be increased. Meanwhile, an inner surface of the diameter increasing part 142 may be formed as a step part 142b stepped in the inner diameter direction.

In FIGS. 6C, 6D, 8A, and 8B, a shape in which an interval increasing part 142 is provided at the upper end portion 149u of the circulation hole 149 of the sleeve 140 is shown. Particularly, the center of the interval increasing part 142 may coincide with that of the circulation hole 149. Since a diameter of the upper end portion 149u of the circulation hole 149 is increased by the interval increasing part 142, an area by which the upper end portion 149u of the circulation hole 149 is overlapped with the first thrust bearing TBu formed by the first thrust dynamic groove 148a may be increased. That is, in FIGS. 6C and 6D, ‘Od1’ may be larger than ‘Od2’.

Referring to FIG. 6C, the upper end portion of the circulation hole 149 of the sleeve 140 may be provided with the interval increasing part 142 having an increased diameter. The interval increasing part 142 may increase a diameter of the upper end portion of the circulation hole 149 based on the same center Ce that of the center Cc of the circulation hole 149. Therefore, a diameter of the upper end portion 149u of the circulation hole 149 may be increased. Meanwhile, an inner surface of the diameter increasing part 142 may be formed as an inclination part 142c having an inclination surface.

Referring to FIG. 6D, the upper end portion of the circulation hole 149 of the sleeve 140 may be provided with the interval increasing part 142 having an increased diameter. The interval increasing part 142 may increase a diameter of the upper end portion of the circulation hole 149 based on the same center Ce that of the center Cc of the circulation hole 149. Therefore, a diameter of the upper end portion 149u of the circulation hole 149 may be increased. Meanwhile, an inner surface of the diameter increasing part 142 may be formed as a step part 142d stepped in the inner diameter direction.

In FIG. 6E, a shape in which a diameter of the circulation hole 149 of the sleeve 140 is increased toward the upward axial direction is shown. When the diameter of the circulation hole 149 increases in the upward axial direction as described above, since a diameter of the upper end portion 149u of the circulation hole 149 becomes larger than that of the lower end portion 149d of the circulation hole 149, an area by which the upper end portion 149u of the circulation hole 149 is overlapped with the first thrust bearing formed by the first thrust dynamic groove 148a may be increased. That is, in FIG. 6E, ‘Od1’ may be larger than ‘Od2’.

In FIG. 6F, a shape in which a diameter decreasing member 140a is inserted into a lower portion of the circulation hole 149 of the sleeve 140 in the axial direction is shown. The diameter decreasing member 140a may be a fitting member in which a hole having a diameter smaller than that of the circulation hole is formed in the axial direction. When the diameter decreasing member 140 is fitted into the lower end portion of the circulation hole 149, such that the diameter of the lower end portion of the circulation hole 149 in the axial direction becomes substantially smaller than that of the upper end portion 149u of the circulation hole 149 in the axial direction, since the diameter of the upper end portion 149u of the circulation hole 149 becomes larger than that of the lower end portion 149d of the circulation hole 149, an area by which the upper end portion 149u of the circulation hole 149 is overlapped with the first thrust bearing formed by the first thrust dynamic groove 148a may be further increased. That is, in FIG. 6F, ‘Od1’ may be larger than ‘Od2’.

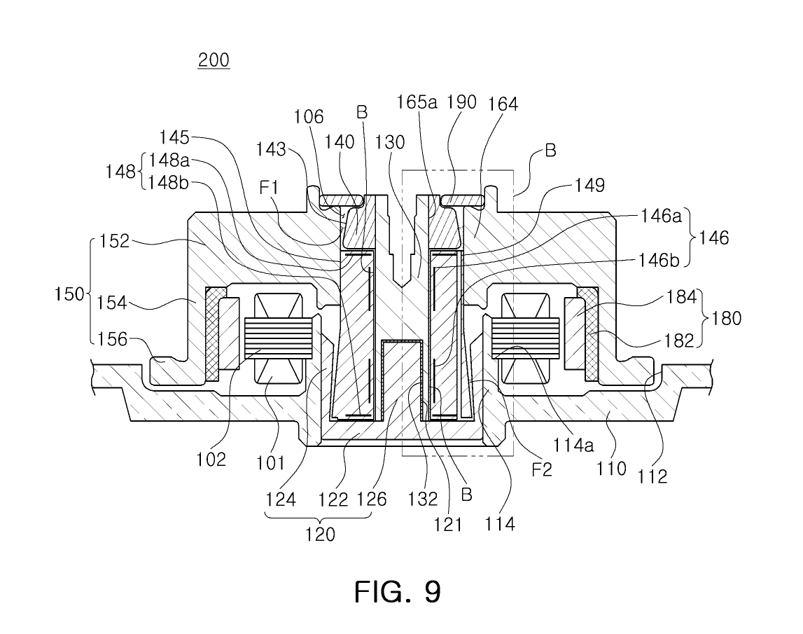

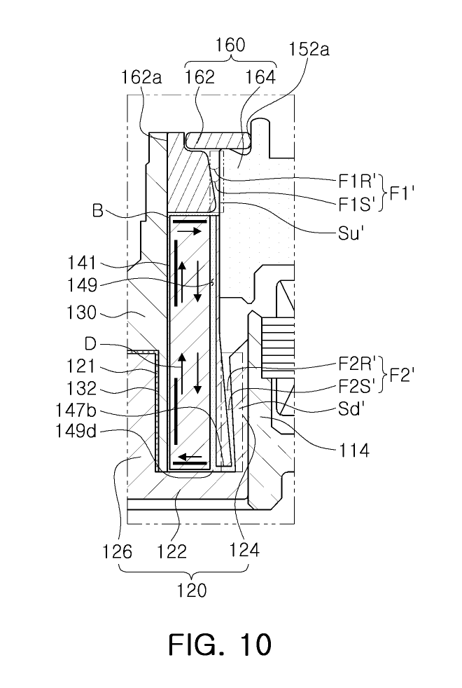

FIG. 9 is a schematic cross-sectional view showing a spindle motor according to another embodiment of the present invention; and FIG. 10 is an enlarged view showing part B of FIG. 9.

In FIGS. 9 and 10, the spindle motor 200 according to another embodiment of the present invention is shown. The spindle motor 200 according to another embodiment of the present invention is different only in a first thrust member and a portion at which a first liquid-vapor interface associated with the first thrust member is formed from the spindle motor 100 according to the embodiment of the present invention. Therefore, the same components as those of the spindle motor 100 according to the embodiment of the present invention will be denoted by the same reference numerals and a detailed description thereof will be omitted, and components different from those of the spindle motor 100 according to the embodiment of the present invention will be mainly described.

The first thrust member 165 may include a fixing hole 165a into which an upper end portion of the shaft 130 is fitted to thereby be fixedly installed on the upper end portion of the shaft 130 and form, together with an inner surface of the rotor hub 150 in the radial direction, a first liquid-vapor interface. Therefore, an outer surface of the first thrust member 165 in the radial direction or an inner surface of the rotor hub 150 in the radial direction may be inclined so that a fluid may be easily sealed.

Meanwhile, the first thrust member 165 may include a fixing hole 165a so that an inner surface thereof is bonded to the shaft 130.

Further, the first thrust member 165 may be insertedly disposed in a space formed by the upper end portion of the outer peripheral surface of the shaft 130, the outer surface of the sleeve 140, and the inner surface of the rotor hub 150.

In addition, the first thrust member 165, which also is a fixed member fixedly installed together with the base member 110, the second thrust member 120, and the shaft 130, may be a member configuring the stator.

In addition, an upper portion of the first thrust member 165 may be provided with a cap member 190. The cap member 190 may cover a space formed by surfaces of the first thrust member 165 and the rotor hub 150 facing in the radial direction over the space. The cap member 190 may be fixedly mounted to the rotor hub 150. In addition, the facing surfaces of the cap member 190 and the first thrust member 160 may be narrow enough to form a labyrinth seal. The facing surfaces of the cap member 190 and the first thrust member 160 may form a clearance of 0.3 mm or less therebetween.

Meanwhile, a first thrust dynamic groove 148a for generating thrust dynamic pressure may be formed in at least one of a lower surface of the first thrust member 165 and the upper surface of the sleeve 140 disposed to face the lower surface of the first thrust member 165.

Meanwhile, in the case in which a rotating member including the sleeve 140 and the rotor hub 150 is rotated, a first thrust bearing may be formed between the sleeve 140 and the first thrust member 160 by the first thrust dynamic groove 148a, and a second thrust bearing may be formed between the sleeve 140 and the second thrust member 120 by the second thrust dynamic groove 148b.

Here, an area by which an upper end portion 149u of the circulation hole 149 in the axial direction is overlapped with the first thrust bearing may be larger than an area by which a lower end portion 149d of the circulation hole 149 in the axial direction is overlapped with the second thrust bearing. This may also be applied to the case in which although not shown, the lower end portion of the circulation hole 149 in the axial direction is formed at an outer side of a region of the second thrust bearing, such that an area by which the lower end portion 149d of the circulation hole 149 in the axial direction is overlapped with the second thrust bearing is not present.

Therefore, in the case in which the rotating member including the sleeve 140 and the rotor hub 150 is rotated, a greater amount of pressure may be generated at the upper end portion 149u of the circulation hole in the axial direction than at the lower end portion 149d of the circulation hole in the axial direction to allow the lubricating fluid to move from an upper portion in the axial direction to a lower portion in the axial direction within the circulation hole 149, thereby effectively preventing the lubricating fluid from being leaked to the outside of the spindle motor through the first liquid-vapor interface F1.

That is, when the rotating member including the sleeve 140 and the rotor hub 150 is rotated, since the lubricating fluid moves in the downward axial direction within the circulation hole 149 by the above-mentioned mechanism, the lubricating fluid may be circulated in a direction of an arrow (D) as shown in FIG. 10.

Therefore, as shown in FIG. 10, when the rotating member including the sleeve 140 and the rotor hub 150 is rotated, the first liquid-vapor interface formed in the first sealing part Su′ may move toward the upper end portion 149u of the circulation hole in the axial direction and the second liquid-vapor interface formed in the second sealing part Sd′ may move toward an opposite side of the lower end portion 149d of the circulation hole in the axial direction. More specifically, the first liquid-vapor interface may move in the downward axial direction (F1S′→F1R′) and the second liquid-vapor interface may move in the upward axial direction (F2S′→F2R′).

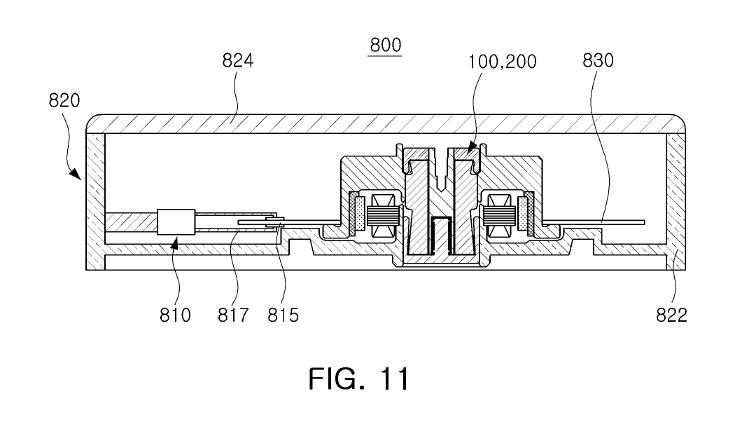

FIG. 11 is a schematic cross-sectional view of a recording disk driving device having a motor according to the embodiment of the present invention mounted therein.

Referring to FIG. 11, a recording disk driving device 800 having the spindle motor 100 or 200 according to the present invention mounted therein may be a hard disk drive and include the spindle motor 100 or 200, a head transfer part 810, and a housing 820.

The spindle motor 100 or 200 may have all features of the motor according to the present invention described above and have a recording disk 830 mounted thereon.

The head transfer part 810 may transfer a magnetic head 815 detecting information of the recording disk 830 mounted in the spindle motor 100 or 200 to a surface of the recording disk of which the information is to be detected.

Here, the magnetic head 815 may be disposed on a support part 817 of the head transfer part 810.

The housing 820 may include a motor mounting plate 822 and a top cover 824 shielding an upper portion of the motor mounting plate 822 in order to form an internal space receiving the motor 100 and the head transfer part 810.

As set forth above, according to the embodiments of the present invention, the spindle motor allowing the lubricating fluid not to be leaked to the outside of the spindle motor even in the case in which the lubricating fluid is leaked to the outside of the liquid-vapor interface may be provided.

In addition, the lubricating fluid leaked through each of the first and second liquid-vapor interfaces included in the spindle motor may be significantly decreased.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a second thrust member fixedly installed on a base member;
a shaft fixedly installed on the second thrust member;
a sleeve disposed above the second thrust member and installed to be rotatable with respect to the shaft;
a rotor hub coupled to the sleeve to thereby be rotated together with the sleeve; and
a first thrust member disposed above the sleeve and fixedly installed on the shaft,
wherein the sleeve includes a circulation hole penetrating therethrough in an axial direction,
the sleeve and the first thrust member include a first thrust bearing formed therebetween and the sleeve and the second thrust member include a second thrust bearing formed therebetween, and
an area by which an upper end portion of the circulation hole in the axial direction is overlapped with the first thrust bearing is larger than an area by which a lower end portion of the circulation hole in the axial direction is overlapped with the second thrust bearing.

2. The spindle motor of claim 1, wherein a cross-sectional area of the upper end portion of the circulation hole in the axial direction is larger than that of the lower end portion of the circulation hole in the axial direction.

3. The spindle motor of claim 2, wherein the upper end portion of the circulation hole in the axial direction is provided with a diameter increasing part having a diameter larger than those of other portions of the circulation hole.

4. The spindle motor of claim 3, wherein a cross section of the circulation hole in the axial direction forms a circle having a predetermined diameter, and
the diameter increasing part is formed as a circle having a diameter larger than those of other portions of the circulation hole.

5. The spindle motor of claim 4, wherein the center of a circle formed by a cross section of the diameter increasing part in the axial direction is offset from those of circles formed by cross sections of other portions of the circulation hole in the axial direction.

6. The spindle motor of claim 1, wherein a cross-sectional area of the upper end portion of the circulation hole in the axial direction is the same as that of the lower end portion of the circulation hole in the axial direction.

7. The spindle motor of claim 1, wherein the circulation hole has a diameter that increases in an upward axial direction.

8. The spindle motor of claim 1, wherein the lower end portion of the circulation hole in the axial direction has a diameter decreasing member in which a hole having a diameter smaller than that of the circulation hole is formed in the axial direction inserted thereinto.

9. The spindle motor of claim 1, wherein the lower end portion of the circulation hole in the axial direction is formed outside of a region of the second thrust bearing.

10. The spindle motor of claim 1, wherein a first sealing part provided between the first thrust member and a member facing the first thrust member in a radial direction is formed as a space smaller than that of a second sealing part provided between the second thrust member and the sleeve.

11. The spindle motor of claim 10, wherein the member facing the first thrust member in the radial direction is the rotor hub.

12. The spindle motor of claim 10, wherein the member facing the first thrust member in the radial direction is the sleeve.

13. The spindle motor of claim 10, wherein the first and second sealing parts are lengthily formed in the axial direction, and
the first and second sealing parts include first and second liquid-vapor interfaces formed therein, respectively.

14. The spindle motor of claim 10, wherein when the shaft is rotated, a first liquid-vapor interface formed in the first sealing part moves toward the upper end portion of the circulation hole in the axial direction and a second liquid-vapor interface formed in the second sealing part moves toward an opposite side of the lower end portion of the circulation hole in the axial direction.

15. The spindle motor of claim 1, wherein a first sealing part provided between the first thrust member and a member facing the first thrust member in a radial direction has an axial length shorter than that of a second sealing part provided between the second thrust member and the sleeve.

16. The spindle motor of claim 1, wherein the circulation hole is inclined with respect to the axial direction.

17. A spindle motor comprising:
a second thrust member fixedly installed on a base member;
a shaft fixedly installed on the second thrust member;
a sleeve disposed above the second thrust member and installed to be rotatable with respect to the shaft;
a rotor hub coupled to the sleeve to thereby be rotated together with the sleeve; and
a first thrust member disposed above the sleeve and fixedly installed on the shaft,
wherein the sleeve includes a circulation hole penetrating therethrough in an axial direction, and
when the shaft is rotated, a greater amount of pressure is generated at an upper end portion of the circulation hole in the axial direction than at a lower end portion of the circulation hole in the axial direction.

18. A hard disk drive comprising:
the spindle motor of claim 1 rotating a disk by power applied thereto through a substrate;
a magnetic head writing data to and reading data from the disk; and
a head transfer part moving the magnetic head to a predetermined position above the disk.
